(19) United States
(12) Patent Application Publication
(10) Pub. No.: US 2024/0389747 A1
(43) Pub. Date: Nov. 28, 2024

(54) FURNITURE ASSEMBLY

(71) Applicant: LEYO HOLDINGS SDN BHD, BATU PAHAT (MY)

(72) Inventor: TECK LAI NG, JOHOR BAHRU (MY)

(73) Assignee: LEYO HOLDINGS SDN BHD, BATU PAHAT (MY)

(21) Appl. No.: 18/227,516

(22) Filed: Jul. 28, 2023

(30) Foreign Application Priority Data
Oct. 17, 2022 (MY) PI2022005769

(51) Int. Cl. A47B 47/04; F16B 5/00

(52) U.S. Cl. CPC A47B 47/042; F16B 5/0016; A47B 2230/0081

(57) ABSTRACT

A furniture assembly is described and includes a plurality of panels interconnected to each other via a first fastening mechanism and a second fastening mechanism, wherein the first fastening mechanism includes one or more pinholes on at least one of the panels and one or more pins extended from at least one of the panels to engage with, and being inserted in, the complementary pinholes, and wherein the second fastening mechanism includes one or more groove channels on at least one of the panels and one or more projecting tongue profiles extended from at least one of the panels to engage with, and being inserted in, the complementary groove channels.

### CROSS-REFERENCE TO RELATED APPLICATION

The instant application claims priority to Malaysia Patent Application Serial No. PI2022005769 filed Oct. 17, 2022, the entire specification of which is expressly incorporated herein by reference.

### FIELD OF THE INVENTION

The present invention relates to a furniture assembly. More particularly, the invention relates to a furniture assembly having a plurality of panels firmly interconnected to each other via multiple fastening mechanisms.

### BACKGROUND OF THE INVENTION

Conventionally, a furniture unit is assembled from a plurality of panels with each panel having a hole with aligns with a corresponding hole of another panel when the panels are assembled. A user will need to use one or more tools such as a hammer to insert a fastening means into the aligned holes such that the panels are secured firmly as an assembly to form the furniture unit. However, this type of furniture unit is not desirable as the assembling process is complicated and time-consuming. To solve these issues, furniture units that do not require additional fastening means and tools have been developed.

One exemplary of these ready-to-assemble furniture units can be referenced from a United States Patent Publication No. US20130071172A1 which discloses a composed furniture element having two or more panels, wherein at least one panel possesses a coupling zone in which coupling parts which are in the form of a tongue and a groove, wherein these tongues and grooves allow coupling the panels to each other in a locking manner at a predetermined angle. One of the limitations of the disclosed composed furniture element is that the assembled furniture element does not have strong structural integrity. The panels interlocked using only the tongue and groove coupling parts at the coupling zones may easily disengage from each other due to external stresses or forces acting on the assembled furniture element. As a result, the disengagement between the panels may also cause the panels to suffer from physical damages.

Accordingly, it would be desirable to provide a furniture assembly having multiple interlocking or fastening mechanisms for providing the furniture assembly that is stronger, sturdier and more stable. The proposed invention provides such a furniture assembly that solves the abovementioned problems.

### SUMMARY OF THE INVENTION

The main objective of the invention is to provide a furniture assembly that can be built without any additional fasteners and tools.

Another objective of the invention is to provide the furniture assembly having multiple interlocking or fastening mechanisms such that the furniture assembly formed is stronger, sturdier and more stable.

The proposed invention provides a furniture assembly comprising: a plurality of panels interconnected to each other via a first fastening mechanism and a second fastening mechanism; wherein the first fastening mechanism includes one or more pinholes on at least one of the panels and one or more pins extended from at least one of the panels to engage with, and being inserted in, the complementary pinholes; and wherein the second fastening mechanism includes one or more groove channels on at least one of the panels and one or more projecting tongue profiles extended from at least one of the panels to engage with, and being inserted in, the complementary groove channels.

In this aspect of the invention, at least one of the panels comprises the one or more pinholes disposed on a surface of the panel for engaging with the one or more complementary pins formed on one or more remaining panels.

In this aspect of the invention, at least one of the panels comprises the one or more pins formed on an edge and/or an opposing edge of the panel for engaging with the one or more complementary pinholes formed on one or more remaining panels.

In this aspect of the invention, at least one of the panels comprises the one or more groove channels disposed on a surface of the panel for engaging with the one or more complementary tongue profiles formed on one or more remaining panels.

In this aspect of the invention, at least one of the panels comprises the one or more tongue profiles formed on one or more edges of the panel for engaging with the one or more complementary groove channels formed on one or more remaining panels.

In this aspect of the invention, at least one of the panels comprises the tongue profile on an edge of the panel and the one or more pins on one or more remaining edges of the panel for engaging with the complementary groove channels and pinholes on one or more remaining panels.

In this aspect of the invention, the one or more tongue profiles are slidably engageable to the complementary groove channels to form tongue and groove interlocking joint connections.

In this aspect of the invention, each pin comprises a locking profile for providing a self-interlocking mechanism between the panels upon engagement with the complementary pinhole.

In this aspect of the invention, the furniture assembly is a Louis Philippe furniture.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows a back panel for use in forming a furniture assembly according to the present invention.

FIG. 2 shows a side panel being installed onto the back panel.

FIG. 3 shows a plurality of front panels being secured onto edges of the side panels.

FIG. 4 shows a top panel being attached to the side panels.

FIG. 5 shows a drawer assembly with at least one drawer side panel engaged to a drawer front panel.

FIG. 6 shows a drawer bottom panel slidably engaged with the drawer side panels.

FIG. 7 shows a drawer back panel being attached to the drawer side panels.

FIG. 8 shows a door pull installed at the drawer front panel.

FIG. 9 shows a preferred embodiment of the furniture assembly.

### DETAILED DESCRIPTION OF THE INVENTION

The invention will now be described in greater detail, by way of example, with reference to the drawings.

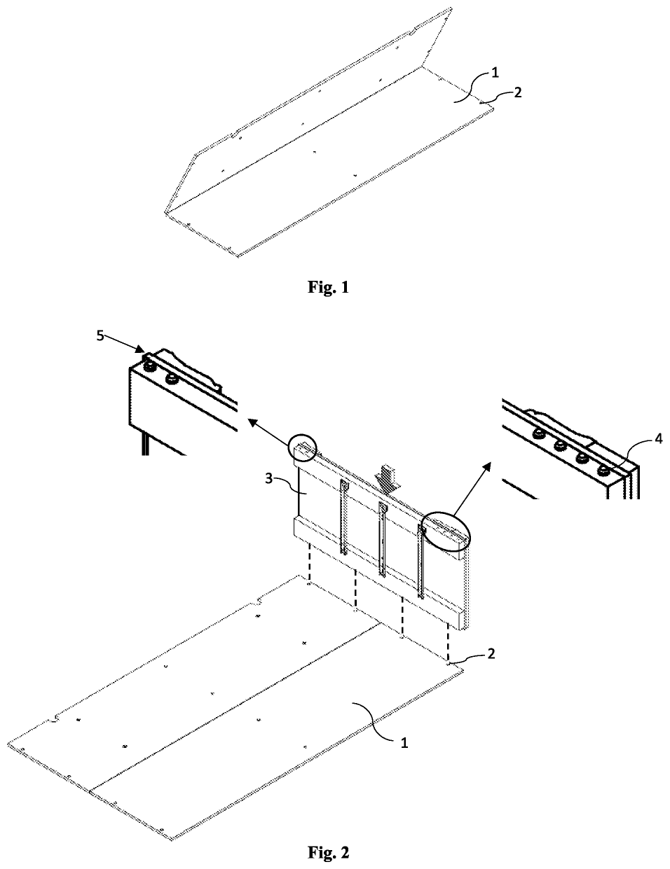

Referring to FIGS. 1 to 9, there is provided a furniture assembly 100 according to the present invention. In a preferred embodiment of the invention, the furniture assembly 100 comprises a plurality of panels 1, 3, 6, 7, 9, 10, 11, 12 interconnected to each other via a first fastening mechanism and a second fastening mechanism. Preferably, the first fastening mechanism includes one or more pinholes 2 disposed on at least one of the panels 1, 3, 6, 7, 9, 10, 11, 12 and one or more pins 4 extended from at least one of the panels 1, 3, 6, 7, 9, 10, 11, 12 to engage with, and being inserted in, the complementary pinholes 2. The second fastening mechanism preferably includes one or more groove channels 8 disposed on at least one of the panels 1, 3, 6, 7, 9, 10, 11, 12 and one or more projecting tongue profiles 7 extended from at least one of the panels 1, 3, 6, 7, 9, 10, 11, 12 to engage with, and being inserted in, the complementary groove channels 8.

Advantageously, a user can assemble the plurality of panels 1, 3, 6, 7, 9, 10, 11, 12 into the furniture assembly 100 without any tools or additional fastening means. Furthermore, the fastening mechanisms allow the user to easily assemble the plurality of panels 1, 3, 6, 7, 9, 10, 11, 12 onto the opposing panels 1, 3, 6, 7, 9, 10, 11, 12 by just aligning the pins 4 with the complementary pinholes 2 and the tongue profiles 5 with the complementary groove channels 8 and press the panels 1, 3, 6, 7, 9, 10, 11, 12 for enhancing securement between the panels 1, 3, 6, 7, 9, 10, 11, 12. Additionally, the furniture assembly 100 formed has strong structural integrity due to the combination of the first and second interlocking mechanisms. The plurality of interconnected panels 1, 3, 6, 7, 9, 10, 11, 12 will not easily disengage from each other due to external stresses or forces acting on the furniture assembly 100.

In the preferred embodiment of the invention, at least one of the panels 1, 3, 6, 7, 9, 10, 11, 12 comprises one or more pinholes 2 that are disposed on a surface of the panel 1, 3, 6, 7, 9, 10, 11, 12 for receiving and engaging with the one or more complementary pins 4 extended from one or more remaining panels 1, 3, 6, 7, 9, 10, 11, 12. Further, at least one of the panels 1, 3, 6, 7, 9, 10, 11, 12 comprises the one or more pins 4 formed on an edge and/or an opposing edge of the panel 1, 3, 6, 7, 9, 10, 11, 12 for engaging with the one or more complementary pinholes 2 formed on one or more remaining panels 1, 3, 6, 7, 9, 10, 11, 12.

In addition, at least one of the panels 1, 3, 6, 7, 9, 10, 11, 12 comprises the one or more groove channels 8 disposed on a surface of the panel 1, 3, 6, 7, 9, 10, 11, 12 for receiving and engaging with the one or more complementary tongue profiles 5 formed on one or more remaining panels 1, 3, 6, 7, 9, 10, 11, 12. Further, at least one of the panels 1, 3, 6, 7, 9, 10, 11, 12 comprises the one or more tongue profiles 5 formed on one or more edges of the panel 1, 3, 6, 7, 9, 10, 11, 12 for engaging with the one or more complementary groove channels 8 formed on one or more remaining panels 1, 3, 6, 7, 9, 10, 11, 12.

In the preferred embodiment, the furniture assembly 100 may further comprise at least one of the panels 1, 3, 6, 7, 9, 10, 11, 12 that comprises at least one tongue profile 5 on an edge of the panel 1, 3, 6, 7, 9, 10, 11, 12 and one or more pins 4 on one or more remaining edges of the panel 1, 3, 6, 7, 9, 10, 11, 12 for engaging with a complementary groove channel 8 and pinholes 2 on one or more remaining panels 1, 3, 6, 7, 9, 10, 11, 12. Additionally, the furniture assembly 100 may further comprise at least one of the panels 1, 3, 6, 7, 9, 10, 11, 12 comprises at least one groove channel 8 and one or more pinholes 2 on the surface of the panel 1, 3, 6, 7, 9, 10, 11, 12 for engaging with the complementary tongue profile 5 and pins 4 on one or more remaining panels 1, 3, 6, 7, 9, 10, 11, 12. Nevertheless, it should be understood that each panel 1, 3, 6, 7, 9, 10, 11, 12 for forming the furniture assembly 100 may comprise different combinations of fastening mechanisms.

Preferably, the one or more tongue profiles 5 disposed on the panels 1, 3, 6, 7, 9, 10, 11, 12 are slidably engageable to the complementary groove channels 8 to form tongue and groove interlocking joint connections. Each groove channel 8 preferably provides upright side walls for receiving the complementary tongue profile 5 which is preferably in a rectangular configuration. However, it should be understood that the groove channel 8 may provide a slanted side wall extending parallel to a longitudinal direction of the groove channel 8, whereby the slanted side wall of the groove channel 8 is juxtaposed with a slanted side wall of the complementary tongue profile 5 when the corresponding panels are connected.

Preferably, each pin 6 of the secondary fastening mechanism of the furniture assembly 100 comprises a locking profile at its open end which is to be inserted and fixedly attached to the complementary pinhole 2 for providing a self-interlocking mechanism between the panels 1, 3, 6, 7, 9, 10, 11, 12 upon engagement with the complementary pinhole 2. By way of example, the locking profile of the pin 6 may be a zig-zag configuration or teeth configuration that locks with the complementary pinhole 2 upon the engagement.

In the preferred embodiment of the invention, the furniture assembly 100 is a Louis Philippe furniture. Preferably, the Louis Philippe furniture is a Louis Philippe dresser as shown in FIG. 9, where the plurality of panels 1, 3, 6, 7, 9, 10, 11, 12 are preferably made of a rigid material such as but is not limited to a wood, a wood composite material, a wood laminate and a wood fiber material. However, it should be understood that the furniture assembly 100 can be all types of furniture that can be assembled using the disclosed fastening mechanisms.

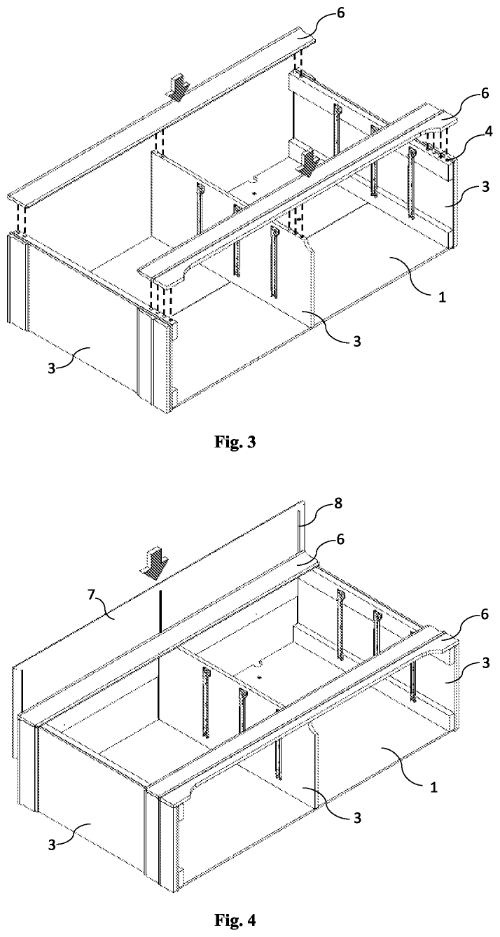

FIGS. 1 to 9 illustrate a process flow of assembling the plurality of panels 1, 3, 6, 7, 9, 10, 11, 12 to build the furniture assembly 100 which is the Louis Philippe dresser. Preferably, the furniture assembly 100 comprises a main body and one or more drawers. FIGS. 1 to 4 illustrate the process flow of assembling the main body of the furniture assembly 100. Referring to FIG. 1, the main body of the furniture assembly 100 comprises a back panel 1 having a plurality of pinholes 2 on a surface of the back panel 1. Preferably, the pinholes 2 are arranged in an array configuration and there are preferably three arrays of pinholes 2 disposed vertically on the surface of the back panel 1. The three arrays of pinholes 2 are arranged at a generally center portion and both distal end portions of the surface of the back panel 1. Referring to FIG. 2, the assembling of the main body of the furniture assembly 100 starts by engaging and inserting complementary pins 4 extended from one edge of three side panels 3 into the three arrays of pinholes 2 of the back panel 1 to form a part of the main body for the furniture assembly 100. Referring to FIG. 3, two front panels 6 are firmly secured to a portion of edges of the side panels 3 by engaging pinholes 2 of the front panels 6 to the complementary pins 4 extended from the opposing edges of three side panels 3 and being retain therein. Referring to FIG. 4, a top panel 7 is attached to the three side panels 3 by slidably engaging three groove channels 8 of the top panel 7 to three complementary projecting tongue profiles 5 where each is disposed on one side of each side panel 3 and being retained therein to form the main body of the furniture assembly 100.

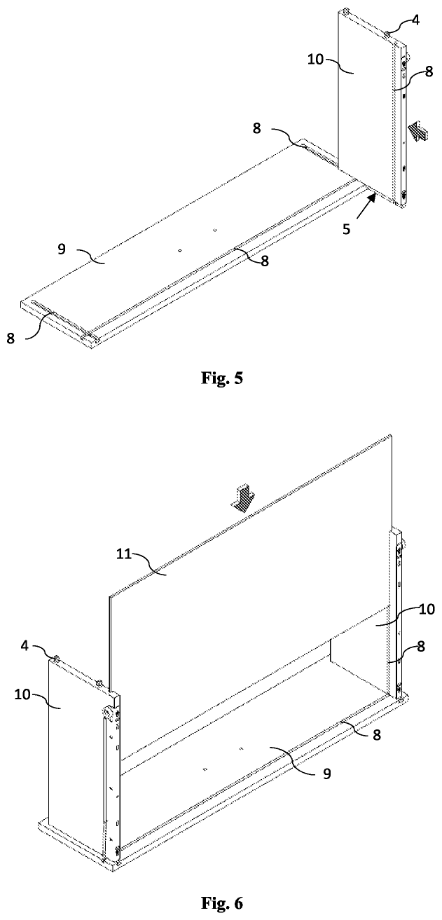

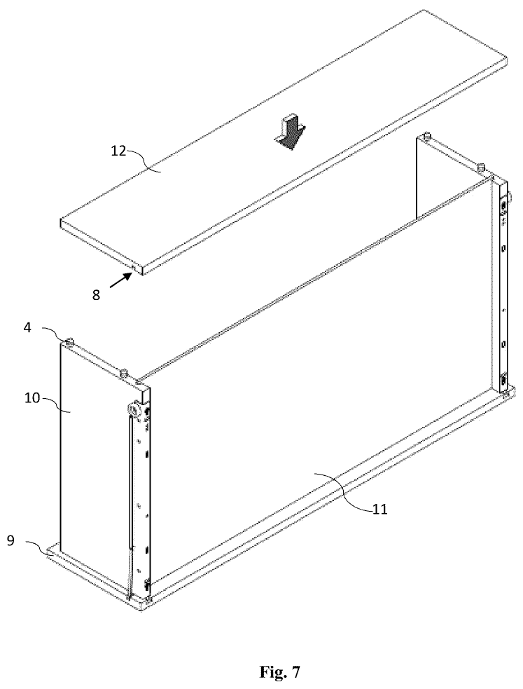

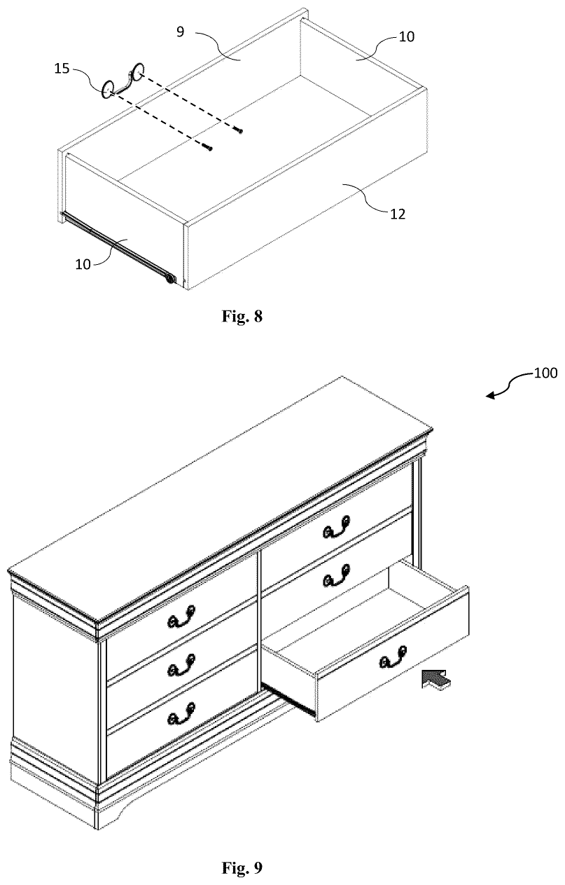

FIGS. 5 to 8 illustrate the process flow of assembling the drawers of the furniture assembly 100. Referring to FIG. 5, the assembling of the drawer of the furniture assembly 100 starts by slidably engaging a projecting tongue profile 5 of a first and second drawer side panel 10 to complementary groove channels 8 of a drawer front panel 9 and being retained therein. Referring to FIG. 6, a bottom panel 11 is slidably engaged with complementary groove channels 8 of the first and second drawer side panels 10, thereby forming a base for the drawer. Referring to FIG. 7, a drawer back panel 12 is attached to the first and second drawer side panels 10 by engaging pinholes 2 and a groove channel 8 of the drawer back panel 12 to pins 4 of the first and second drawer side panels 10 and a projecting portion of the bottom panel 11 upon engaged with the drawer side panels 10 respectively. Referring to FIG. 8, each drawer is preferably installed with a door pull 15 at the drawer front panel 9 for allowing a user to easily push or pull the drawer out of the main body of the furniture assembly 100.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A furniture assembly, comprising:
a plurality of panels interconnected to each other via a first fastening mechanism and a second fastening mechanism;
wherein the first fastening mechanism includes one or more pinholes on at least one of the panels and one or more pins extended from at least one of the panels to engage with, and being inserted in, complementary pinholes; and
wherein the second fastening mechanism includes one or more groove channels on at least one of the panels and one or more projecting tongue profiles extended from at least one of the panels to engage with, and being inserted in, complementary groove channels.

2. The furniture assembly according to claim 1, wherein at least one of the panels comprises the one or more pinholes disposed on a surface of the panel for engaging with the one or more complementary pins formed on one or more remaining panels.

3. The furniture assembly according to claim 1, wherein at least one of the panels comprises the one or more pins formed on an edge or an opposing edge of the panel for engaging with the one or more complementary pinholes formed on one or more remaining panels.

4. The furniture assembly according to claim 1, wherein at least one of the panels comprises the one or more groove channels disposed on a surface of the panel for engaging with the one or more complementary tongue profiles formed on one or more remaining panels.

5. The furniture assembly according to claim 1, wherein at least one of the panels comprises the one or more tongue profiles formed on one or more edges of the panel for engaging with the one or more complementary groove channels formed on one or more remaining panels.

6. The furniture assembly according to claim 1, wherein at least one of the panels comprises at least one tongue profile on an edge of the panel and one or more pins on one or more remaining edges of the panel for engaging with the complementary groove channel and pinholes on one or more remaining panels.

7. The furniture assembly according to claim 1, wherein at least one of the panels comprises at least one groove channel and one or more pinholes the surface of the panel for engaging with the complementary tongue profile and pins on one or more remaining panels.

8. The furniture assembly according to claim 1, wherein the one or more tongue profiles are slidably engageable to the complementary groove channels to form tongue and groove interlocking joint connections.

9. The furniture assembly according to claim 1, wherein each pin comprises a locking profile for providing a self-interlocking mechanism between the panels upon engagement with the complementary pinhole.

10. The furniture assembly according to claim 1, wherein the furniture assembly is configured in a Louis Philippe style piece of furniture.
